(19) United States
(12) Patent Application Publication
(10) Pub. No.: US 2011/0069651 A1
(43) Pub. Date: Mar. 24, 2011

(54) CONSERVING POWER USING CONTENTION-FREE PERIODS THAT LACK NETWORK TRAFFIC

(75) Inventors: Shantanu KANGUDE, Dallas, TX (US); Ariton E. XHAFA, Plano, TX (US); Harshal CHHAYA, Plano, TX (US)

(73) Assignee: TEXAS INSTRUMENTS INCORPORATED, Dallas, TX (US)

(21) Appl. No.: 12/725,174

(22) Filed: Mar. 16, 2010

Related U.S. Application Data
(60) Provisional application No. 61/160,518, filed on Mar. 16, 2009.

(51) Int. Cl. H04W 40/00; H04W 52/02

(52) U.S. Cl. 370/311; 370/338

(57) ABSTRACT

A method that comprises receiving, by an access point (AP), an interval value from a station (STA). The interval value corresponds to a frequency with which the STA listens to the AP. The method also comprises commanding, by the AP, the STA to refrain from transmitting data to the AP until a period expires. The commanding comprises the AP setting a duration of the period to correspond to the interval value. The method further comprises transferring, by the AP, data to the STA after the period expires.

### CROSS-REFERENCE TO RELATED APPLICATION

The present application claims priority to U.S. Provisional Patent Application No. 61/160,518, filed on Mar. 16, 2009 (Attorney Docket No. TI-67817PS), which is hereby incorporated herein by reference.

### BACKGROUND

Various wireless devices (e.g., access points and stations) may communicate with each other by way of a network, such as a wireless local area network (WLAN) that adopts any suitable protocol (e.g., 802.11x). At least some of these wireless devices may be battery-operated, meaning that their power resources are finite and should be conserved to the extent possible.

### SUMMARY

The problems noted above are solved in large part by a technique that enables various devices in a wireless network to remain in a power-conservation mode for extended periods of time, thereby conserving power. In some embodiments, the technique comprises a method that includes receiving, by an access point (AP), an interval value from a station (STA). The interval value corresponds to a frequency with which the STA listens to the AP. The method also comprises commanding, by the AP, the STA to refrain from transmitting data to the AP until a period expires. The commanding comprises the AP setting a duration of the period to correspond to the interval value. The method further comprises transferring, by the AP, data to the STA after the period expires.

In some embodiments, the technique comprises a method that includes a station (STA) transmitting an interval value to an access point (AP). The interval value corresponds to a frequency with which the STA listens to the AP. The interval value is less than additional interval values of other STAs with which the AP communicates. As a result of receiving a command from the AP, the STA refrains from transmitting data to the AP until a period expires and the STA powers down at least some data transmission circuitry during the period. A duration of the period corresponds to the interval value. The method also comprises receiving, by the STA, data from the AP after the period expires.

In some embodiments, the technique is implemented in a system that comprises a transceiver and a processor coupled to the transceiver that receives an interval value from a station (STA). The interval value corresponds to a timing with which the STA listens to the transceiver. The processor commands the STA to cease data transmissions to the transceiver until a period expires. A duration of the period associates with the interval value. The transceiver does not transmit data to the STA during the period. After the period expires, the transceiver is reactivated and transmits data to the STA.

In some embodiments, the technique is implemented in a system that comprises a transceiver and a processor coupled to the transceiver. The transceiver transmits an interval value to an access point (AP). The interval value corresponds to a timing with which the processor listens for signals from the AP. The processor does not transmit data to the AP until a period expires and the transceiver is powered down during the period. The period has a duration that corresponds to the interval value. The transceiver reactivates and sends a signal to the AP after the period expires.

### BRIEF DESCRIPTION OF THE DRAWINGS

For a detailed description of exemplary embodiments of the invention, reference will now be made to the accompanying drawings in which:

FIG. 1 shows a block diagram of an illustrative system implementing the techniques disclosed herein in accordance with embodiments;

FIGS. 2a-2b show additional block diagrams of a device of the system of FIG. 1 implementing the techniques disclosed herein in accordance with embodiments;

FIG. 3 shows a timing diagram that illustrates Contention-Free Periods (CFPs) and Contention Periods (CPs);

FIG. 4 shows another timing diagram, in accordance with embodiments; and

FIGS. 5-6 show flow diagrams of methods that may be implemented in accordance with embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. In some embodiments, to “power down” means to partially or completely deactivate. In some embodiments, to “power down” means to reduce power supply. In some embodiments, to “power up” means to partially or completely activate. In some embodiments, to “power up” means to increase power supply.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein is a technique that enables various devices in a wireless network to remain in a power-conservation mode for extended periods of time, thereby conserving power. The technique comprises a set of interactions between a wireless access point (AP) and wireless stations (STAs). Generally, the technique comprises the AP instructing the STAs to remain in a “quiet mode” (i.e., to refrain from transmitting data on the network and to power down any circuit logic that does not need to be active when the STA is refraining from transmitting data on the network) for as long as possible. During this quiet mode, the AP also refrains from transmitting data on the network and powers down any circuit logic that does not need to be active when the AP is refraining from transmitting data on the network. The quiet mode is interrupted at predetermined intervals to ensure that the STAs have an opportunity to transmit and receive data from the AP. In some embodiments, these predetermined intervals correspond to the frequency at which the STAs check the network for signals from the AP, as explained below. In some embodiments, the technique is implemented using any of a variety of 802.11 or other protocols.

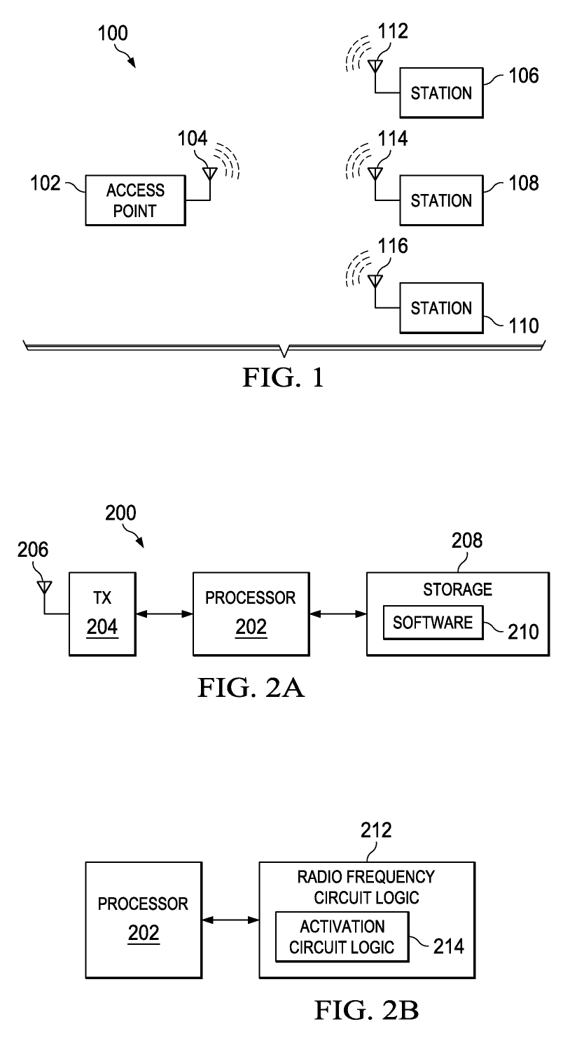

FIG. 1 shows an illustrative block diagram of a system network 100 implementing the technique in accordance with embodiments. The network 100 includes, for instance, a wireless local area network (WLAN) that enables devices to communicate using any of a variety of suitable protocols (e.g., an 802.11 protocol; all 802.11 protocols are incorporated herein by reference). These network 100 devices include an access point (AP) 102 comprising an antenna 104, a first station (STA) 106 comprising an antenna 112, a second STA 108 comprising an antenna 114, and a third STA 110 comprising an antenna 116. Suitable replacements may be used in lieu of the antennas shown in FIG. 1. The AP 102 and STAs 106, 108, 110 may comprise the same or different types of devices and may comprise, among other things, desktop, laptop, notebook and netbook computers; mobile communication devices including mobile phones and personal digital assistants; and other suitable, battery-operated, wireless communication devices.

FIG. 2a shows an illustrative block diagram of a device 200 of the network 100 of FIG. 1. The device 200 is a general representation of any or all of the AP 102 and the STAs 106, 108, 110. The AP 102 and the STAs 106, 108, 110 may be more complex than the general representation of the device 200 shown in FIG. 2a. The device 200 comprises a processor 202 that couples with a transceiver 204, an antenna 206, and storage 208. The storage 208 comprises software 210. When executed by the processor 202, the software 210 causes the processor 202 to perform some or all of the actions that are described herein and that are attributed to that particular device 200. For instance, as a consequence of executing the software 210, the processor 202—embedded in the AP 102—performs some or all of the actions attributed herein to the AP 102. The device 200 may include additional circuit logic, as desired.

Referring again to FIG. 1, in some embodiments, the AP 102 and the STAs 106, 108, 110 function in a master-slave relationship. Stated another way, the AP 102 dictates at least some of the functions of the STAs 106, 108, 110, and particularly how those STAs interact with other devices on the network 100. Accordingly, the AP 102 periodically broadcasts a beacon signal to the STAs 106, 108, 110. The beacon signal comprises various information that synchronizes the network 100 and ensures that the STAs 106, 108, 110 and the AP 102 are “on the same page.”

In some embodiments, the AP 102 may broadcast a beacon to the STAs 106, 108, 110 that instruct the STAs 106, 108, 110 to enter a mode known in 802.11 protocol as the Point Coordination Function (PCF). The PCF is a mode that enables the AP 102 to act as master to the slave STAs 106, 108, 110. The PCF, in turn, contains two sub-modes. When the network 100 operates in the first of these sub-modes, known as the Contention Free Period (CFP), the AP 102 coordinates network traffic among the STAs 106, 108, 110, giving each STA an opportunity to transmit data to and receive data from the AP 102 without interruption from the other STAs (contention arises due to the limited amount of traffic that the network 100 can support). When the network 100 operates in the second of these sub-modes, known as the Contention Period (CP), each of the STAs 106, 108, 110 attempts to send data to and receive data from the AP 102 amid contention with other STAs (i.e., without direction or network resource allocation from the AP 102). The AP 102 causes the network 100 to enter the CFP sub-mode using a beacon signal that it broadcasts to the STAs 106, 108, 110. The AP 102 causes the network 100 to exit the CFP sub-mode and enter the CP sub-mode using an appropriate command signal that is broadcast to the STAs 106, 108, 110, such as the Contention Free end (CF_end) command. Once in the CP sub-mode, the AP 102 may again cause the network 100 to enter the CFP sub-mode using a beacon signal that is broadcast to the STAs 106, 108, 110.

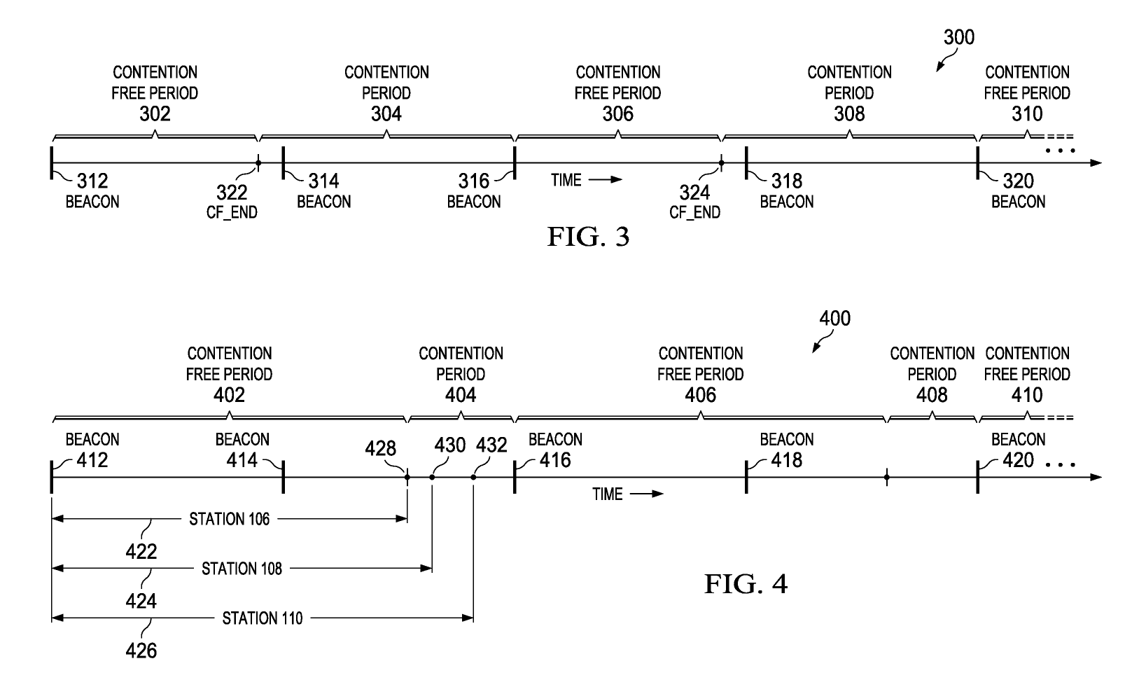

FIG. 3 shows a timing diagram 300 that illustrates these sub-modes. Specifically, the diagram 300 includes beacons 312, 314, 316, 318 and 320, each of which is broadcast by the AP 102 to the STAs 106, 108, 110. The timing diagram 300 also comprises CFP and CP sub-modes 302, 304, 306, 308 and 310. In particular, the AP 102 causes the network 100 to enter the CFP sub-mode using beacon 312. As explained, when the network 100 is in the CFP sub-mode, the AP 102 dictates which STAs 106, 108, 110 may transmit or receive data and when they may do so. Subsequently, the AP 102 causes the network 100 to enter the CP sub-mode by broadcasting a CF_end signal or other appropriate signal (i.e., at points 322 and 324). As explained, when the network 100 is in the CP sub-mode, the STAs 106, 108, 110 attempt to send and receive data without direction from the AP 102. Thus, still referring to FIG. 3, the beacon 312 initiates the CFP 302; the CF_end 322 initiates the CP 304; the beacon 316 initiates the CFP 306; the CF_end 324 initiates the CP 308; and the beacon 320 initiates the CFP 310.

FIG. 4 shows another timing diagram 400 in accordance with embodiments. The diagram 400 includes beacons 412, 414, 416, 418 and 420. Each of these beacons is broadcast by the AP 102 to the STAs 106, 108, 110. The timing diagram 400 also comprises CFP and CP sub-modes 402, 404, 406, 408 and 410. In contrast to the CFPs and CPs of the timing diagram 300 and in accordance with embodiments, however, the AP 102 adjusts the time durations of the CFPs and CPs of the timing diagram 400 in accordance with parameters obtained from the STAs 106, 108, 110. In some embodiments, these parameters include “listen intervals.” An STA's listen interval is an indication of how frequently the STA will “listen,” or monitor/check the network 100, for a signal from the AP 102, such as a beacon signal or other instruction. Listen intervals may be programmed as desired or the STAs may determine their own listen intervals. In the example shown in FIG. 4, the STA 106 has a listen interval 422, while STA 108 has a listen interval 424 and the STA 110 has a listen interval 426. In accordance with embodiments, the STAs 106, 108, 110 transmit their respective listen intervals to the AP 102. The STA 106, 108, 110 listen intervals may be pre-programmed or may be self-determined by the STAs upon association with the network 100. In turn, the AP 102 compares the listen intervals received from the various STAs and adjusts the length of the CFPs (e.g., CFP 402, 406, 410) to match the shortest listen interval received from among the STAs. In the example shown, the STA 106 has the shortest listen interval (i.e., listen interval 422), so the AP 102 adjusts the durations of the CFPs to match the duration of listen interval 422. Points 428, 430 and 432 signify the endpoints of the listen intervals 422, 424 and 426, respectively. Stated another way, the points 428, 430 and 432 are those at which the STAs 106, 108, and 110 exit power conservation mode (or “sleep” mode) and notify the AP 102 (e.g., using a Power Save Poll (PSPoll) signal or some other suitable signal) that it is once again ready to exchange data with the AP 102.

Justifying such an adjustment is the fact that any information that the AP 102 transmits before the STAs 106, 108, 110 listen to the AP 102 will be of no use because none of the STAs will hear that information. Because no transmissions are sent from the AP 102 to an STA 106, 108, 110 or from an STA 106, 108, 110 to the AP 102 prior to expiry of the STA 106's listen interval 422, radio circuitry housed within the AP 102 and the STAs 106, 108, 110 preferably are deactivated to conserve power and extend battery life. Thus, during the CFP 402 and subsequent CFPs, the AP 102 refrains from communicating with the STAs 106, 108, 110 and powers down some or all of its radio circuit logic (e.g., transceiver 204). Similarly, during the CFP 402 and subsequent CFPs, each of the STAs 106, 108, 110 refrains from communicating with the AP 102 and powers down some or all of its radio circuit logic (e.g., transceiver 204). As a result, the battery lives of the AP 102 and the STAs 106, 108, 110 are extended.

FIG. 2b illustrates how the processor 202 powers up and powers down various components during CFPs. In some embodiments, the processor 202, upon the start of a CFP mode, will power down some or all of radio frequency (RF) circuit logic 212. Such circuit logic 212 includes the transceiver 204 and may include any other suitable circuit logic used to communicate with other devices in the network 100. In some embodiments, the processor 202 powers up and powers down the RF circuit logic 212 using activation circuit logic 214. The activation circuit logic 214 may include, for instance, various switches and other suitable circuitry that enables the processor 202 to activate and deactivate some or all of the RF circuit logic 212.

Referring to FIGS. 3 and 4, the CFP 402 is longer in duration than is the CFP 302. As explained, this is true because the AP 102 extends the CFP 402's duration to match or otherwise correspond to the duration of the shortest listen interval among the listen intervals 422, 424, 426 (in the present case, listen interval 422). Thus, both the CFP 402 and the listen interval 422 terminate at point 428. Although a beacon 414 is shown in FIG. 4 to explain how beacon signals are timed, in at least some embodiments, the AP 102 sends no beacon signals during the CFP 402 or any other CFP. Nevertheless, in such embodiments, the CFP 402 may still be said to comprise at least one beacon interval because—although the AP 102 does not actually transmit the beacon 414—the scheduled beacon interval (i.e., the Target Beacon Transmit Time, or TBTT) still falls at the time indicated by beacon 414 in FIG. 4. In some embodiments, the AP 102 may send beacon signals in one or more CFPs so that new STAs joining the network 100 may be able to synchronize with other devices in the network 100. In some such embodiments, the STAs 106, 108, 110 do not receive the AP 102's beacon signals because the STAs 106, 108, 110 are asleep (i.e., in a power-conservation mode).

Because of the information it has received from the STAs 106, 108, 110, the AP 102 is cognizant of the fact that at point 428, the STA 106 will listen to the network 100 for signals from the AP 102. Thus, at point 428, the AP 102 broadcasts a CF_end signal (or other appropriate signal) that tells all listening STAs that the CFP 402 has ended. At point 428, the STA 106 is listening and, thus, the STA 106 transmits a signal (e.g., a PSPoll) to the AP 102 indicating that it is ready to exchange data with the AP 102. Because the STAs 108, 110 are not yet awake, the STA 106 generally will be able to communicate with the AP 102 unhindered. At point 430, however, the STA 108 wakes up because its listen interval 424 has expired. Upon exiting power conservation mode, the STA 108 transmits a signal to the AP 102 (e.g., a PSPoll signal) notifying the AP 102 that the STA 108 is ready to exchange data with the AP 102. Similarly, at point 432, the STA 110 arises and notifies the AP 102 that it is ready to receive data from and/or transmit data to the AP 102.

In some embodiments, the AP 102 may prematurely terminate a CFP by broadcasting a CF_end signal if it so desires. In some embodiments, the AP 102 may choose to transmit data downstream to an STA 106, 108, 110 during the CFP sub-mode, despite the fact that the AP 102 and the STAs 106, 108, 110 preferably remain in a “sleep” mode during CFPs. The AP 102 may accomplish this by broadcasting a beacon 412 that instructs only some STAs to go to sleep. The STA(s) to which the AP 102 expects to transmit during the CFP may remain outside the sleep mode.

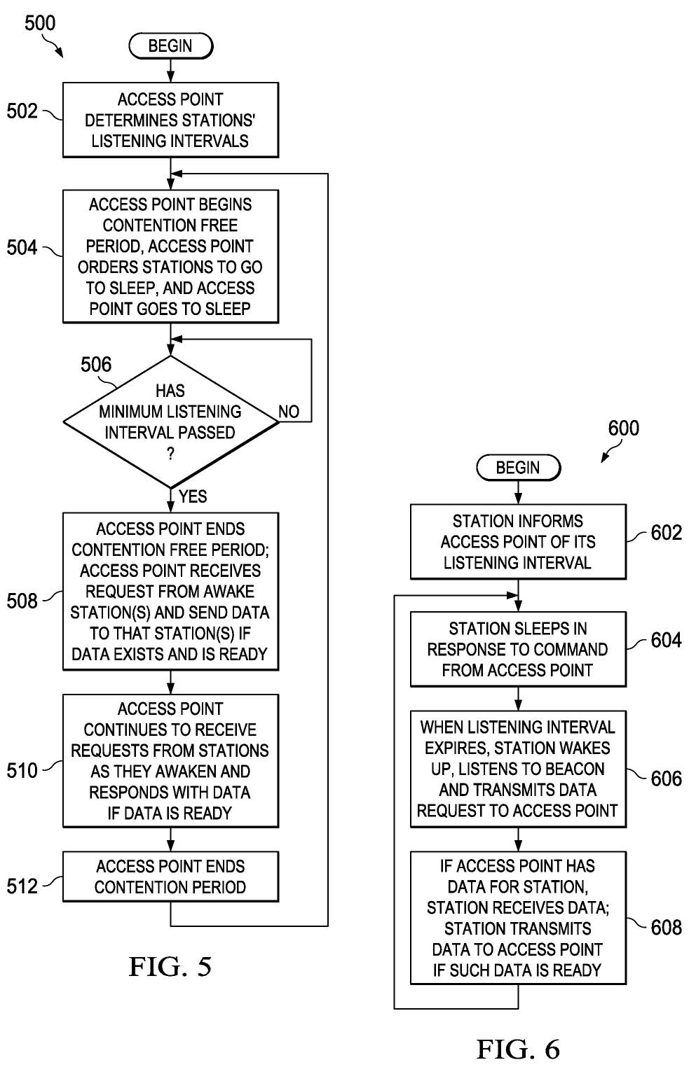

FIG. 5 shows a flow diagram of an illustrative method 500 in accordance with embodiments. The method 500 begins with the AP determining the STAs' listening intervals (block 502). As explained, the AP is able to determine the STAs' listening intervals because the STAs transmit this information to the AP. The method 500 also comprises the AP beginning the CFP period; the AP ordering the STAs to enter sleep mode; and the AP itself going to sleep (block 504). The method 500 further comprises the AP determining whether the minimum listening intervals among all listening intervals of the STAs has passed (block 506). If so, the method 500 continues with the AP terminating the CFP and receiving a request from any awake STA(s) and sending data to such STA(s) if data exists for those STA(s) and is ready for transmission (block 508). The method 500 further comprises the AP continuing to receive requests from STAs as they awaken and responding with data if such data exists and is ready for transmission (block 510). The method 500 still further comprises the AP terminate the CP period (block 512). Control of the method 500 is then returned to block 504. The steps of the method 500 may be altered as desired (e.g. the steps may be rearranged or deleted or additional steps may be added to the method 500).

FIG. 6 shows a flow diagram of an illustrative method 600 in accordance with embodiments. The method 600 comprises an STA informing the AP of its listening interval (block 602). The method 600 also comprises the STA sleeping (i.e., entering a power-conservation mode) in response to a command received from the AP (block 604). The method 600 further comprises the STA, upon expiration of its listening interval, waking up (i.e., exiting power-conservation mode), listening to the beacon, and transmitting a data request to the AP (block 606). The method 600 still further comprises the STA receiving data from the AP if the AP has such data for the STA and if the data is ready for transmission and the STA transmitting data to the AP if the STA has such data and the data is ready for transmission (block 608). The steps of the method 600 may be altered as desired (e.g., the steps may be rearranged or deleted or additional steps may be added to the method 500).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
receiving, by an access point (AP), an interval value from a station (STA), wherein the interval value corresponds to a frequency with which the STA listens to said AP;
commanding, by the AP, said STA to refrain from transmitting data to said AP until a period expires, wherein said commanding comprises the AP setting a duration of said period to correspond to said interval value; and
transferring, by the AP, data to said STA after said period expires.

2. The method of claim 1, further comprising selecting, by the AP, said interval value from among multiple other interval values received from multiple STAs as a result of said interval value being smaller than said other interval values.

3. The method of claim 1, further comprising the AP refraining from transmitting data to the STA until said period expires.

4. The method of claim 3, further comprising the AP transmitting data to another STA during said period.

5. The method of claim 1, further comprising:
the AP performing said receiving, commanding, and transferring steps in accordance with a wireless local area network (WLAN) 802.11 protocol;
transmitting, by the AP, multiple beacon signals; and
commanding, by the AP, said STA to refrain from transmitting data to the AP for a period that comprises a Contention Free Period (CFP) that includes at least one beacon interval.

6. The method of claim 1, wherein said AP comprises a mobile communication device.

7. The method of claim 1, further comprising the AP powering down at least some data transmission circuit logic of the AP during said period.

8. A method, comprising:
a station (STA) transmitting an interval value to an access point (AP), wherein the interval value corresponds to a frequency with which the STA listens to said AP, and wherein said interval value is less than additional interval values of other STAs with which the AP communicates;
as a result of receiving a command from the AP, the STA refraining from transmitting data to the AP until a period expires and the STA powering down at least some data transmission circuitry during said period, a duration of said period corresponds to said interval value; and
receiving, by the STA, data from the AP after said period expires.

9. The method of claim 8, wherein said STA comprises a mobile communication device.

10. The method of claim 8, further comprising the STA receiving no data from the AP during said period.

11. The method of claim 8, further comprising receiving, by the STA, an indication from the AP that the AP contains data for the STA and further comprising the STA transmitting a Power Save Poll (PSPoll) signal to the AP to request said data after said period is complete.

12. A system, comprising:
a transceiver; and
a processor coupled to said transceiver that receives an interval value from a station (STA), said interval value corresponds to a timing with which the STA listens to the transceiver;
wherein the processor commands the STA to cease data transmissions to the transceiver until a period expires, a duration of the period associates with said interval value;
wherein the transceiver does not transmit data to the STA during said period;
wherein, after said period expires, the transceiver is reactivated and transmits data to said STA.

13. The system of claim 12, wherein the processor selects the interval value from among a plurality of other interval values associated with other STAs with which the transceiver communicates, said interval value is the lowest among the other interval values.

14. The system of claim 12, wherein the system comprises a mobile communication device.

15. The system of claim 12, wherein the transceiver is powered down during said period.

16. The system of claim 12, wherein the transceiver transmits data to another STA during said period.

17. A system, comprising:
a transceiver; and
a processor coupled to the transceiver;
wherein the transceiver transmits an interval value to an access point (AP), the interval value corresponds to a timing with which the processor listens for signals from the AP;
wherein the processor does not transmit data to the AP until a period expires and the transceiver is powered down during said period, the period has a duration that corresponds to the interval value;
wherein the transceiver reactivates and sends a signal to the AP after said period expires.

18. The system of claim 17, wherein said interval value is less than additional interval values of other STAs with which the AP communicates.

19. The system of claim 17, wherein said period includes at least one beacon interval.

20. The system of claim 17, wherein the system comprises a mobile communication device.
